(19) United States
(12) Patent Application Publication
(10) Pub. No.: US 2004/0218968 A1
(43) Pub. Date: Nov. 4, 2004

(54) Hinge lock indicator for center-folding ladder

(76) Inventors: Jeffrey Beaver, Indianapolis, IN (US); Tom Meyers, Fishers, IN (US)

Correspondence Address: BARNES & THORNBURG, 11 SOUTH MERIDIAN, INDIANAPOLIS, IN, 46204

(21) Appl. No.: 10/808,866

(22) Filed: Mar. 25, 2004

Related U.S. Application Data
(60) Provisional application No. 60/467,220, filed on May 1, 2003.

(51) Int. Cl. F16D 1/12

(52) U.S. Cl. 403/95

(57) ABSTRACT

A hinge and locking assembly includes first and second hinge members that, when locked, are prevented from rotating about an axis and that, when unlocked, are permitted to rotate about the axis and a lock indicator member movable between a retracted position when the hinge members are locked and an extended position when the hinge members are unlocked. A user is able to determine whether the hinge members are locked or unlocked by observing whether the lock indicator member is in the retracted position or the extended position.

This application claims priority under 35 U.S.C. § 119(e) to U.S. Provisional Application Ser. No. 60/467,220, filed May 1, 2003, which is expressly incorporated by reference herein.

### BACKGROUND

The present disclosure relates to a center-folding ladder, and more particularly to a hinge and locking assembly for a center-folding ladder.

Ladders are commonly used for a variety of applications and are of two general types. One type is a center-folding ladder, commonly called a step ladder, which is self-supporting. Step ladders are typically used for such tasks as pruning, painting ceilings, or other similar tasks where it is difficult or inconvenient to lean the ladder against a structure, such as a wall, for support. The other type of ladder is the straight extension ladder. This type of ladder is simply leaned against the wall or some other structure when standing or climbing on the ladder.

Ladders which are constructed so that they may be used as both step ladders and as straight extension ladders have been known in the art. Such ladders, commonly referred to as combination step and extension ladders, are very versatile and they combine the desirable features of both types of ladders. Such combination ladders typically include a hinge and locking assembly at each end. The hinge and locking assemblies permit the ladder to be folded into and locked in a step ladder configuration or unfolded into and locked in a straight extension ladder configuration. Examples of combination ladders are U.S. Pat. Nos. 3,912,043; 4,566,150; and 4,770,559 which are incorporated herein by reference.

### SUMMARY

One or more of the following features or elements or combinations thereof may be incorporated into a hinge and a locking assembly.

A hinge and locking assembly is provided. Such an assembly may be used, for example, to couple sections of a center-folding ladder. It will be appreciated that such an assembly may have various uses. Such a hinge and locking assembly permits the ladder to be folded into and locked in a step ladder configuration or unfolded into and locked in an extension ladder configuration.

The assembly includes first and second hinge members that, when locked, are prevented from rotating about an axis and that, when unlocked, are permitted to rotate about the axis and a lock indicator member movable between a retracted position when the hinge members are locked and an extended position when the hinge members are unlocked. A user is able to determine whether the hinge members are locked or unlocked by observing whether the lock indicator member is in the retracted position or the extended position.

A lock is movable between a locking position in which the hinge members are locked to prevent the hinge members from rotating about the axis and a releasing position in which the hinge members are unlocked to permit the hinge members to rotate about the axis. A knob is rotatable about the axis and movable along the axis. A cam is configured to move the lock from the locking position to the releasing position in response to movement of the knob axially toward the hinge members and then rotation of the knob about the axis. The hinge members are rotatably mounted on a drive shaft. The knob and the cam are mounted on the drive shaft for rotation therewith. The lock is coupled to the drive shaft for axial movement toward and away from the hinge members.

The drive shaft includes a bore for receiving the lock indicator member for axial movement. The lock indicator member has a first end configured to engage the knob when the knob is moved axially toward the hinge members and a second end. The lock is mounted on the lock indicator member near the second end for axial movement therewith. The second end of the lock indicator member extends through an opening in a cover when the hinge members are unlocked. The second end of the lock indicator member retracts into the cover when the hinge members are locked.

Features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a center-folding ladder having at each end a pair of legs coupled together by a hinge and locking assembly in accordance with this disclosure which permit the ladder to be folded into and locked in a step ladder configuration or unfolded into and locked in a straight extension ladder configuration,

FIGS. 2-4 are end views showing the ladder moving from a collapsed configuration in FIG. 2 (also referred to as a 0° configuration), to a step ladder configuration in FIG. 3 (also referred to as a folded or 40° configuration) and then to a straight extension ladder configuration in FIG. 4 (also referred to as a fully open or 180° configuration),

FIGS. 5-7 are end views similar to FIGS. 2-4 showing the ladder moving from the extension ladder configuration in FIG. 5 to the collapsed configuration in FIG. 7 through an intermediate configuration in FIG. 6,

FIG. 8 is an exploded perspective view of a first embodiment of a hinge and locking assembly, and showing, from left to right, front outer covers, locking bar support pin, locking bar, snap spring, knob support pin, drive shaft (also referred to as cam drive shaft), tri-lobe lifting cam, front support plate, rear support plate, locking plate, detent plate, spring clip, knob spring, winged hex drive, lock washer, rear outer covers, and knob,

FIG. 9 is an exploded perspective view, similar to FIG. 8, of a second embodiment of a hinge and locking assembly having knob rotation limiter and hinge lock indicator features, and showing, from left to right, front outer covers, locking bar support pin, locking bar, snap spring, drive shaft, lifting cam, front support plate, spacer, rear support plate, locking plate, detent plate, spring clip, knob spring, knob assembly, and rear outer covers,

FIG. 10 is an exploded perspective view of the knob assembly of FIG. 9, and showing, from left to right, lock washer, slip disc, slip disc rotation spring and knob,

FIG. 11 is a perspective view of the knob of FIG. 10 showing a pair of forwardly-extending radial ribs,

FIG. 12 is a perspective view of the locking plate of FIG. 9,

FIG. 13 is an elevation view of the locking plate of FIG. 12 as viewed from the end of the FIG. 9 hinge and locking assembly having the knob assembly, and

FIG. 14 shows details of the locking plate.

### DETAILED DESCRIPTION

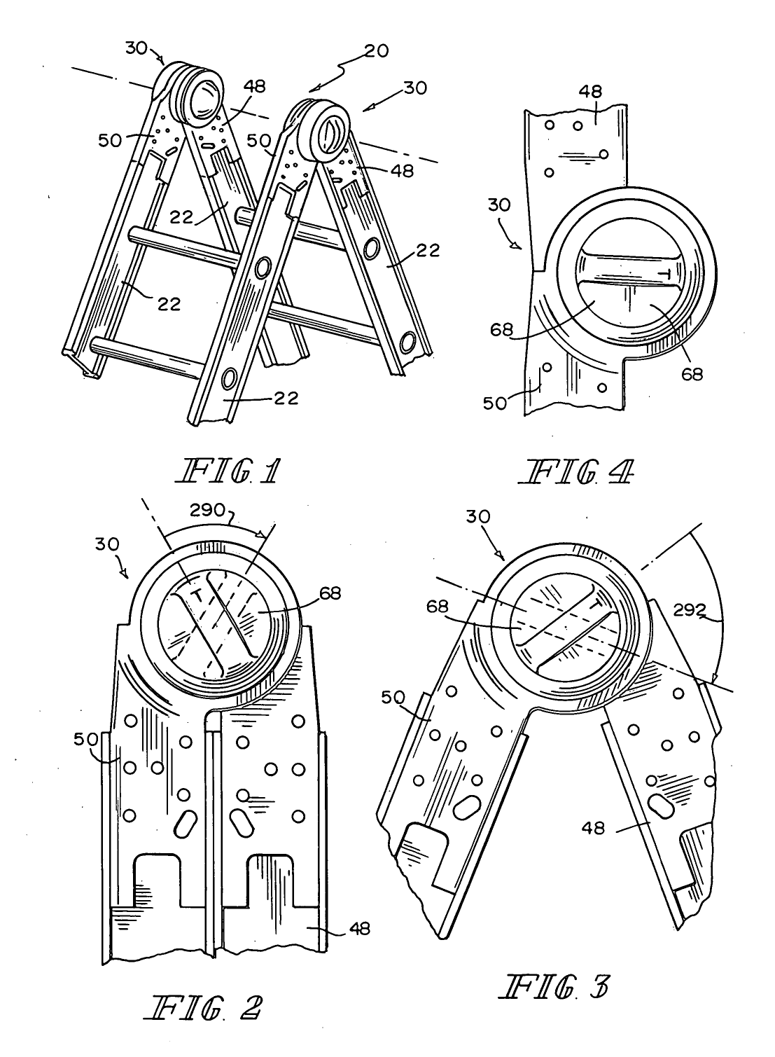

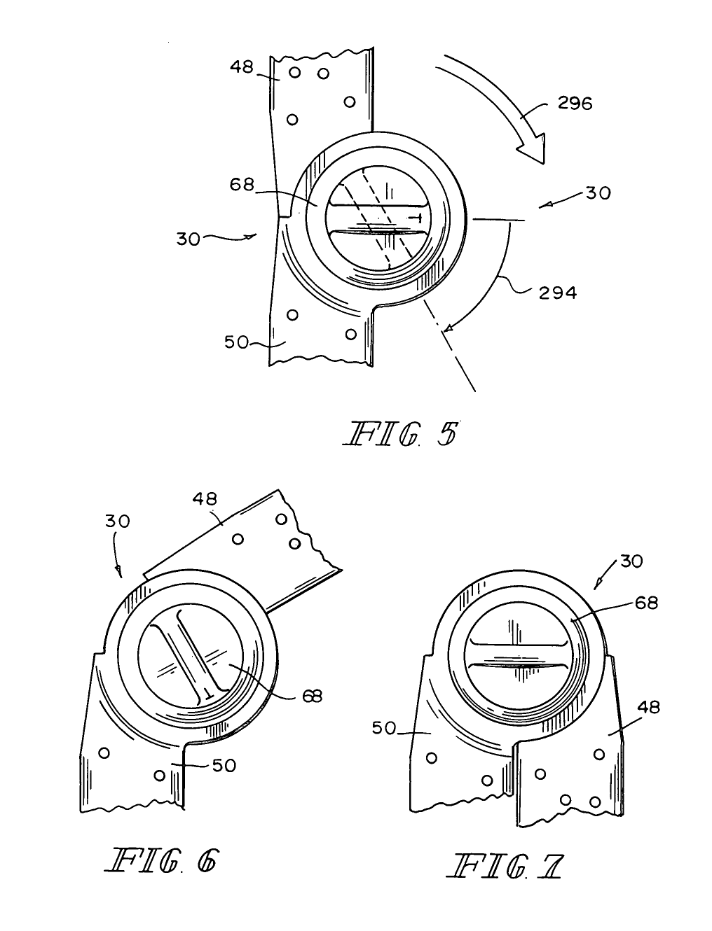

A perspective view of a center-folding ladder 20 having at each end a pair of legs 22 coupled together by a hinge and locking assembly 30 is shown in FIG. 1. Hinge and locking assembly 30 at each end permits ladder 20 to be folded into and locked in a step ladder configuration shown in FIG. 3 or unfolded into and locked in an extension ladder configuration as shown in FIG. 4. To move ladder 20 from the collapsed configuration in FIG. 2 to the step ladder configuration shown in FIG. 3, each knob 68 is pushed inward and rotated 60° clockwise (identified by numeral 290 in FIG. 2) to unlatch hinge and locking assemblies 30 and legs 22 are then spread apart. The rotated position of knob 68 is shown by the dotted lines in FIG. 2. When legs 22 move to the step ladder configuration shown in FIG. 3, hinge and locking assemblies 30 automatically latch to lock legs 22 securely in the step ladder configuration. Hinge and locking assembly 30 is sometimes referred to herein as a “lockable joint.”

To move ladder 20 from the step ladder configuration in FIG. 3 to the extension ladder configuration shown in FIG. 4, each knob 68 is again pushed inward and rotated 60° clockwise (identified by numeral 292 in FIG. 3) to unlatch hinge and locking assemblies 30 and legs 22 are then moved to the fully open position. The rotated position of knob 68 is shown by the dotted lines in FIG. 3. When legs 22 move to the extension ladder configuration shown in FIG. 4, the hinge and locking assemblies 30 automatically latch to lock legs 22 securely in the extension ladder configuration.

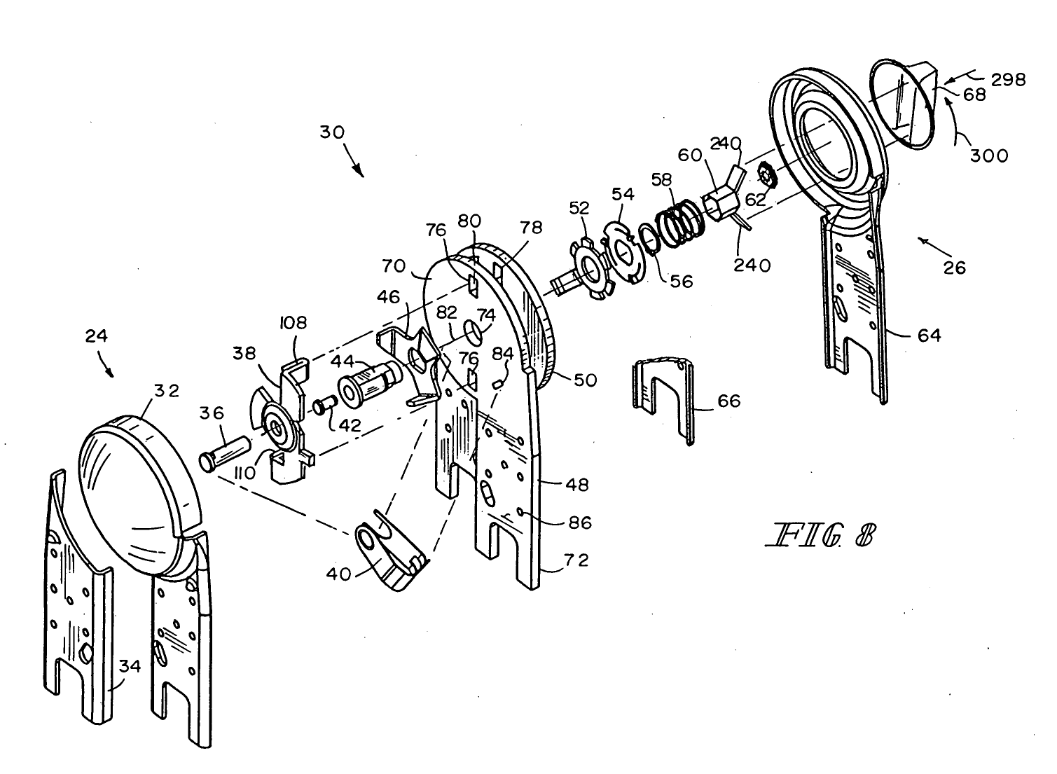

To move ladder 20 from the extension ladder configuration in FIG. 5 to the collapsed configuration shown in FIG. 7, each knob 68 is again pushed inward and rotated 60° clockwise (identified by numeral 294 in FIG. 5) to unlatch hinge and locking assemblies 30 and legs 22 are brought together as shown in FIGS. 6 and 7. The rotated position of knob 68 is shown by the dotted lines in FIG. 5, and the direction of rotation is shown therein by numeral 296. When legs 22 move to the collapsed configuration shown in FIG. 7, hinge and locking assemblies 30 automatically latch to lock legs 22 securely in the collapsed configuration. Hinge and locking assemblies 30 do not lock the ladder as ladder 20 passes through the step ladder configuration during movement of the ladder 20 from the extension ladder configuration in FIG. 5 to the collapsed configuration in FIG. 7. The two hinge and locking assemblies 30 on the opposite sides of center-folding ladder 20 are identical.

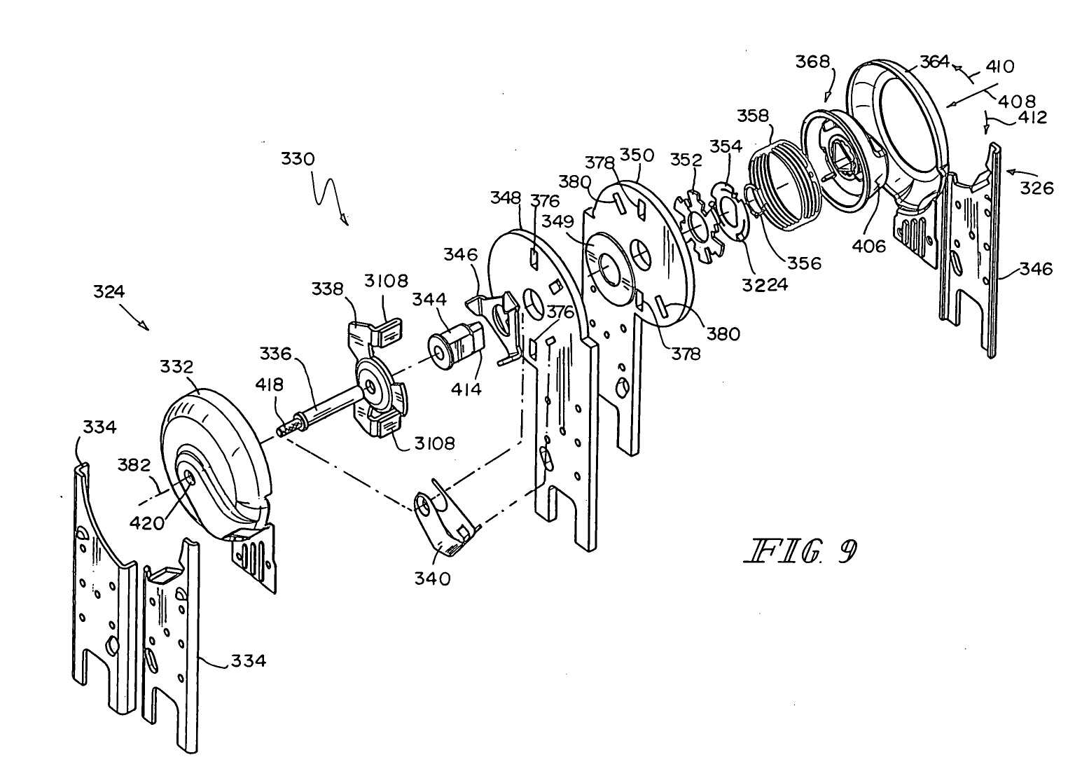

An exploded perspective view of a first embodiment of hinge and locking assembly 30 is shown in FIG. 8. Hinge and locking assembly 30 does not include two features included in the second embodiment of hinge and locking assembly 330 shown in FIGS. 9-14—i.e., the knob rotation limiter feature and the hinge lock indicator feature. As shown in FIG. 8, hinge and locking assembly 30 includes, from left to right, front outer covers 32, 34, a locking bar support pin 36, a locking bar 38, a U-shaped snap spring 40 (also referred to as the formed spring), a knob support pin 42, a drive shaft 44 (also referred to as the cam shaft), a tri-lobe lifting cam 46, a front support plate 48, a rear support plate 50, a locking plate 52, a detent plate 54, a spring clip 56, a knob spring 58, a winged hex drive 60, a lock washer 62, rear outer covers 64, 66, and a lock release knob 68. Front and rear support plates 50, 52 are also sometimes referred to herein as the hinge members, and locking bar 38 is sometimes referred to herein as the lock.

In this disclosure, the terms “front”, “raised”, “advanced”, “upward”, “forward” and “head end” all mean toward end 24 of hinge and locking assembly 30 having locking bar 38 and lifting cam 46. On the other hand, the terms “back”, “lowered”, “retracted”, “backward”, “downward”, “rear” and “foot end” mean toward end 26 of hinge and locking assembly 30 having knob 68. Unless specified otherwise, all rotational directions (clockwise or anticlockwise) are referenced from end 26 of hinge and locking assembly 30 having knob 68. Also, the terms “slot”, “hole”, “opening”, “aperture”, etc. are synonymous in this disclosure.

Hinge and locking assembly 30 is described in detail in a U.S. patent application Ser. No. ______ (Attorney Docket No. 20341-73011), filed on Serial No., and entitled “Hinge and Locking Assembly For Center-Folding Ladder”, which is hereby incorporated by reference in its entirety. The operation of hinge and locking assembly 30 is, however, summarized briefly below.

To move ladder 20 from the collapsed configuration shown in FIG. 2 to the step ladder configuration shown in FIG. 3, knob 68 is first pushed inward against knob spring 58 in a direction 298 to cause hex drive 60 to engage a hex drive portion of drive shaft 44 so that knob 68 can be rotated about 60° in a clockwise direction 300 to, in turn, rotate drive shaft 44 and lifting cam 46 also about 60° in clockwise direction 300. As lifting cam 46 rotates, the inclined leading edges of lifting cam 46 engage the corresponding leading edges of locking bar 38 to lift locking bar 38 away from support plates 48, 50 against the force of snap spring 40. Lifting locking bar 38 away from support plates 48, 50 withdraws locking tabs 108, 110 out of locking slots 78 in rear support plate 50 to unlock hinge and locking assembly 30 to, in turn, permit relative movement of support plates 48, 50 relative to each other. Legs 22 of ladder 20 are then spread apart. When ladder 20 arrives at the step ladder configuration shown in FIG. 3, locking tabs 108, 110 are driven through slots 80 in rear support plate 50 to lock hinge and locking assembly 30.

To move ladder 20 from the step ladder configuration shown in FIG. 3 to the extension ladder configuration shown in FIG. 4, hinge and locking assembly 30 is again unlocked by pushing knob 68 inward and turning it through about 60° in clockwise direction 300. As previously indicated, clockwise rotation of knob 68 through about 60° causes clockwise rotation of drive shaft 44 and lifting cam 46 also through about 60° in clockwise direction 300. As lifting cam 46 rotates, locking bar 38 is lifted away from support plates 48, 50 against the force of snap spring 40. Lifting locking bar 38 away from support plates 48, 50 withdraws locking tabs 108, 110 out of locking slots 80 in rear support plate 50 to unlock hinge and locking assembly 30 to, in turn, permit relative movement of support plates 48, 50 relative to each other. Legs 22 of ladder 20 are then spread apart. When ladder 20 arrives at the extension ladder configuration shown in FIG. 4, locking tabs 108, 110 are driven through slots 78 in rear support plate 50 to lock hinge and locking assembly 30 in the extension ladder configuration.

To move ladder 20 back to the collapsed configuration shown in FIG. 2, hinge and locking assembly 30 is unlocked by pushing knob 68 inward and turning it through about 60° in clockwise direction 300. Rotation of knob 68 causes locking bar 38 to move away from support plates 48, 50 to permit relative movement of support plates 48, 50 relative to each other. Legs 22 of ladder 20 are then brought together. When legs 22 again arrive at the collapsed configuration in FIG. 2, locking tabs 108, 110 are driven through slots 78 in rear support plate 50 to lock the assembly 30 in the collapsed configuration. It is noted that while tabs 108, 110 are withdrawn from slots 78 or 80 in rear support plate 50 when locking bar 38 is lifted, tabs 108, 110 remain extended into slots 76 in front support plate 48. As previously indicated, the assembly and operation of hinge and locking assembly 30 is described in detail in the afore-mentioned U.S. patent application Ser. No. ______ (Attorney Docket No. 20341-73011), Serial No.

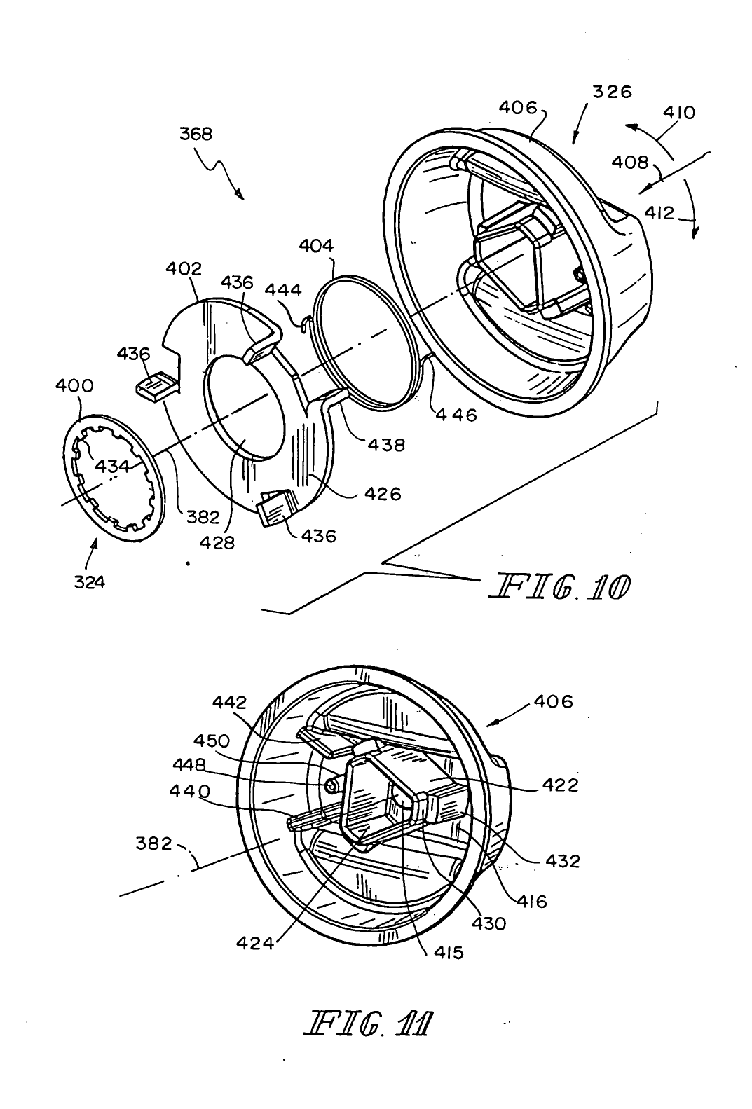

An exploded perspective view, similar to FIG. 8, of the second embodiment of hinge and locking assembly 330 is shown in FIG. 9. As previously indicated, hinge and locking assembly 330 includes two features not included in the first embodiment of hinge and locking assembly 30—i.e., the knob rotation limiter feature and the hinge lock indicator feature. Like elements in the two embodiments 30, 330 generally bear the same reference numerals, except that the reference numerals in second embodiment 330 are preceded by a numeral “3”. Thus, hinge and locking assembly 330 includes, from left to right, front outer covers 332, 334, a locking bar support pin 336, a locking bar 338, a snap spring 340, a drive shaft 344, a lifting cam 346, a front support plate 348, a spacer 349, a rear support plate 350, a locking plate 352, a detent plate 354, a spring clip 356, a knob spring 358, a knob assembly 368, and rear outer covers 364, 366. In FIG. 9, numerals 324, 326, and 382 refer to the front end, the back end and the common axis of hinge and locking assembly 330. As shown in FIG. 10, knob assembly 368 includes, from left to right, a lock washer 400, a slip disc 402, a slip disc rotation spring 404, and a knob 406. As indicated above, all rotational directions (clockwise or counter-clockwise) are referenced from end 326 of assembly 330 having knob assembly 368.

Slip disc 402 cooperates with locking plate 352 to provide the knob rotation limiter feature which limits the rotation of knob 406 to about 60° to 70° each time knob 406 is pushed inward in direction 408 against the bias of knob spring 358 and turned in a clockwise direction 410 to unlock the hinge and locking assembly 330. Each time knob 406 is pushed in and turned clockwise to unlock hinge and locking assembly 330, knob 406 must be first released so that slip disc 402 resets itself before knob 406 can be operated again to unlock hinge and locking assembly 330 a second time. This ensures that the user does not overshoot the rotation of knob 406 beyond 60° to 70° required to unlock hinge and locking assembly 330 to maintain the integrity of the operation of hinge and locking assembly 330.

Unlike the first embodiment 30, hinge and locking assembly 330 does not include a knob support pin, such as knob support pin 42 in FIG. 8. Instead, knob 406 is slidably supported on a rearwardly extending portion 414 of drive shaft 344. Drive shaft 344 includes a bore for receiving locking bar support pin 336 for axial movement therein. A first end of locking bar support pin 336 extends through drive shaft 344 near knob 406 and engages a forwardly-extending boss 415 on inside wall 416 (FIG. 11) of knob 406 so that, when knob 406 is pushed inward in direction 408, a second end 418 of locking bar support pin 336 extends through a window 420 in front cover 332 to provide visual indication that knob 406 is pushed in. Thus, when knob 406 is pushed in and turned clockwise to unlock hinge and locking assembly 330, second end 418 of the locking bar support pin 336 extends through window 420 in front cover 332 to provide visual indication that hinge and locking assembly 330 is unlocked. Second end 418 of locking bar support pin 336 may be painted with a suitable color, such as red, to warn the user when assembly 330 is unlocked. Locking bar 338 is mounted on locking bar support pin 336 near second end 418 for axial movement therewith. Thus, locking bar support pin 336 supports locking bar 338, and also serves as the “lock indicator member.”

Referring to FIGS. 10 and 11, knob 406 includes a triangular-shaped hub portion 422 extending forwardly from inside wall 416 of knob 406. Triangular-shaped hub portion 422 has a triangular-shaped bore 424. The walls defining triangular-shaped hub portion 422 are generally congruent with the walls of triangular-shaped bore 424. Triangular-shaped rearwardly-extending portion 414 of drive shaft 344 is slidably received in triangular-shaped bore 424 in knob 406 to rotationally couple knob 406 to drive shaft 344. Triangular-shaped portion 414 of drive shaft 344 is sized for a close-fit sliding reception in triangular-shaped bore 424 so that knob 406 can freely slide back-and-forth relative to drive shaft 344 while transmitting the rotation of knob 406 to drive shaft 344. As in the first embodiment 30, knob 406 and drive shaft 344 can only rotate in the clockwise direction 410. Locking plate 352 and detent plate 354 cooperate to prevent knob 406 and drive shaft 344 from rotating in counterclockwise direction 412.

Slip disc 402 includes an annular portion 426 having a central bore 428 configured to rotatably receive triangular-shaped hub portion 422 of knob 406. Triangular-shaped hub portion 422 has rounded corner portions 430 to facilitate rotation of slip disc 402 relative to knob 406 about common axis 382 of hinge and locking assembly 330. Central bore 428 in slip disc 402 and hub portion 422 of knob 406 are so sized that that slip disc 402 is free to rotate and slide back-and-forth relative to hub portion 422. Each rounded corner portion 430 of knob 406 is formed include an outwardly-extending step portion 432. Slip disc 402 and slip disc rotation spring 404 are positioned on hub portion 422 of knob 406 between step portions 432 and lock washer 400.

Lock washer 400 includes inwardly-extending teeth 434 along its inner periphery which are configured to engage rounded corner portions 430 of hub portion 422 to secure lock washer 400 to hub portion 422. The inside diameter of inwardly-extending teeth 434 and the outside diameter of hub portion 422 are dimensioned to provide a friction or interference fit. Slip disc rotation spring 404 biases slip disc 402 in clockwise direction 410 relative to knob 406 to transmit the rotation of knob 406 to slip disc 402.

Slip disc 402 has three radially-extending tabs 436 which extend forwardly toward locking plate 352 secured to rear support plate 350. Slip disc 402 has one radially-extending tab 438 which extends rearwardly toward inside wall 416 of knob 406. Forwardly and rearwardly-extending tabs 436, 438 are generally perpendicular to the plane of slip disc 402. Rearwardly-extending tab 438 is positioned between two radial ribs 440, 442 (shown in FIG. 11) extending forwardly from inside wall 416 of knob 406. Radial ribs 440, 442 subtend an angle of about 35° at the common axis 382.

Reception of rearwardly-extending tab 438 of slip disc 402 between two forwardly-extending radial ribs 440, 442 in knob 406 limits rotation of slip disc 402 relative to knob 406 to about 35°, the angle between ribs 440, 442. A forwardly-extending end 444 of slip disc rotation spring 404 is inserted through a hole (not shown) in slip disc 402 to secure forwardly-extending end 444 of slip disc rotation spring 404 to slip disc 402. A rearwardly-extending end 446 of slip disc rotation spring 404 is inserted through a hole 448 in a boss 450 extending forwardly from inside wall 416 of knob 406 to secure rearwardly-extending end 446 of slip disc rotation spring 404 to knob 406. Thus, slip disc rotation spring 404 biases slip disc 402 in clockwise direction 410 relative to knob 406 to, in turn, bias rearwardly-extending tab 438 of slip disc 402 against forwardly-extending radial rib 440 (FIG. 11) of knob 406.

Locking plate 352 serves two functions. As in first embodiment 30, locking plate 352 cooperates with detent plate 354 to allow only clockwise rotation of knob 406 and drive shaft 344 in direction 410, while preventing anticlockwise rotation of knob 406 and drive shaft 344 in direction 412. Also, locking plate 352 cooperates with slip disc 402 to provide a knob rotation limiter feature so that each time knob 406 is pushed in and turned clockwise to unlock hinge and locking assembly 330, knob 406 must be first released before knob 406 can be operated again to unlock hinge and locking assembly 330 a second time. Detent plates 54, 354 in two embodiments 30, 330 are generally similar.

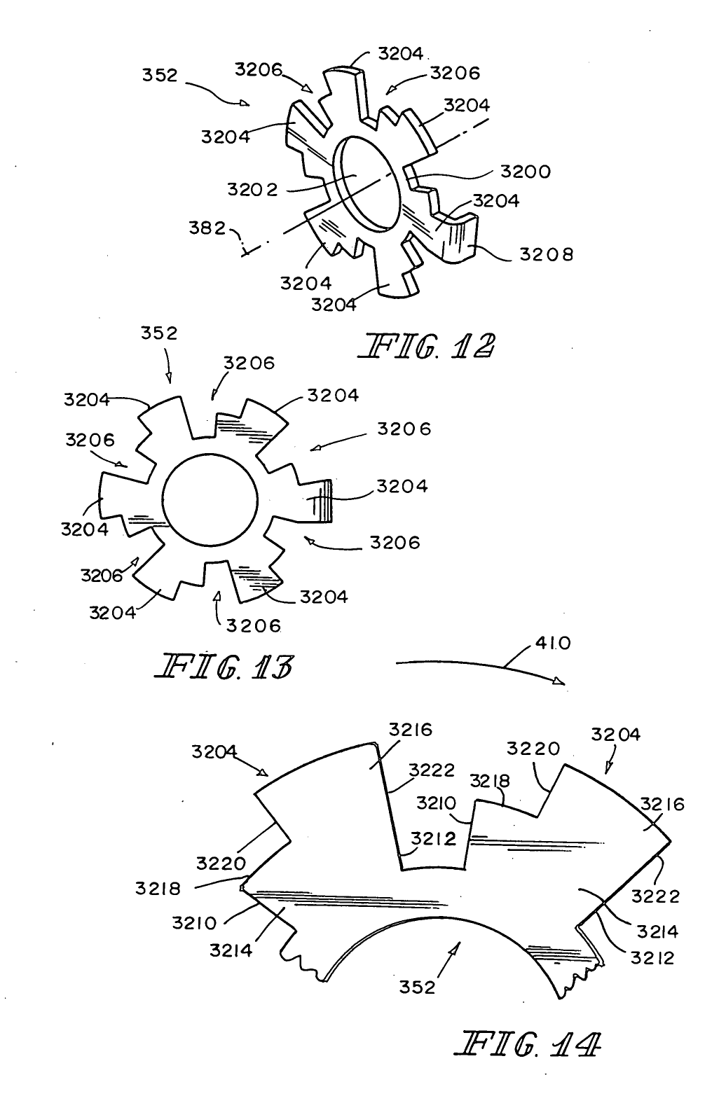

Referring to FIGS. 12-14, locking plate 352 includes an annular portion 3200 having a central bore 3202 and six segments 3204 which extend radially outwardly from annular portion 3200. Drive shaft 344 is configured to be rotatably received in central bore 3202, and is freely rotatable therein. The six segments 3204 are separated by six cutouts 3206. Each of six cutouts 3206 forms a 20° angle at the common axis 382. One of segments 3204 is formed to include a positioning tab 3208 at one end thereof which extends perpendicularly from the plane of locking plate 352. As in the first embodiment, positioning tab 3208 is received in a positioning hole (not shown) in rear support plate 350 to maintain the orientation of locking plate 352 relative to rear support plate 350. As shown in FIG. 14, each of six segments 3204 has a stub portion 3214 that forms a 40° angle and an extended portion 3216 that forms a 25° angle at common axis 382. Each stub portion 3214 and the associated extended portion 3216 form a step portion 3218 that forms a 15° angle at common axis 382.

Each stub portion 3214 has a leading edge 3210 and a trailing edge 3212. As in the first embodiment, leading and trailing edges 3210, 3212 of the stub portions 3214 of locking plate 352 cooperate with the respective detent portions 3224 (FIG. 9) of detent plate 354 to block counter-clockwise rotation of drive shaft 344 in direction 412, while allowing clockwise rotation thereof in direction 410. Each extended portion 3216 of locking plate 352 has a leading edge 3220 and a trailing edge 3222. Leading and trailing edges 3220, 3222 of extended portions 3216 of locking plate 352 cooperate with three forwardly-extending tabs 436 of slip disc 402 to provide the knob rotation limiter feature. Forwardly-extending tabs 436 of slip disc 402 are dimensioned to engage leading and trailing edges 3220, 3222 of extended portions 3216 of locking plate 352 when knob 406 is pushed in to unlock hinge and locking assembly 330. However, it is noted that forwardly-extending tabs 436 of slip disc 402 are sufficiently spaced apart to provide radial clearance for detent plate 354 so that detent plate 354 can rotate with drive shaft 344 when knob 406 is pushed in and rotated without any hindrance from forwardly-extending tabs 436 of the slip disc 402.

The assembly and operation of hinge and locking assembly 330 is similar to the operation of hinge and locking assembly 30 except that hinge and locking assembly 330 has knob rotation limiter and the hinge lock indicator features. As previously indicated, the knob rotation limiter feature limits the rotation of knob 406 to about 60° to 70° each time knob 406 is pushed inward and turned clockwise in direction 410 to unlock hinge and locking assembly 330. Knob 406 must be first released so that slip disc 402 resets itself before knob 406 can be operated again to unlock hinge and locking assembly 330 a second time. The hinge lock indicator feature provides visual indication to the user when hinge and locking assembly 330 is locked.

As indicated above, locking plate 352 cooperates with detent plate 354 to block counter-clockwise rotation of knob 406, drive shaft 344 and lifting cam 346 in direction 412. When knob 406 is not pushed in, locking bar 338 blocks rotation of lifting cam 346 in the clockwise direction 410 to, in turn, block the rotation of drive shaft 344 and knob 406 in clockwise direction 410. When knob 406 is pushed in, knob 406, drive shaft 344 and lifting cam 346 can be rotated in the clockwise direction 410. When knob 406 is pushed in, (1) locking bar support pin 336 is pushed in because locking bar support pin 336 extends through drive shaft 344 and engages boss 415 on inside wall 416 of knob 406, (2) locking bar 338 is pushed in against the bias of snap spring 340 because locking bar 338 is fixed to locking bar support pin 336, (3) locking tabs 3108 (FIG. 9) partially retract out of tab-receiving slots 378 or 380 in rear support plate 350, but not enough to free support plates 348, 350 to rotate relative to each other, and (4) locking bar 338 no longer blocks rotation of lifting cam 346 in the clockwise direction 410 to, in turn, free drive shaft 344 and knob 406 to rotate in clockwise direction 410.

At this point, with knob 406 pushed in, knob assembly 368 is at a starting position of a new unlocking cycle or sequence. At the starting position, (1) forwardly-extending tabs 436 of slip disc 402 are just past respective trailing edges 3222 (FIG. 14) of locking plate 352 secured to rear support plate 350, and (2) rearwardly-extending tab 438 of slip disc 402 is positioned between first and second radial ribs 440, 442 (FIG. 11) extending forwardly from inside wall 416 of knob 406. Rearwardly-extending tab 438 of slip disc 402 is normally in engagement with first radial rib 440 of knob 406 under the bias of slip disc rotation spring 404.

With knob 406 pushed in, knob 406 is rotated in clockwise direction 410. Slip disc 402 rotates with knob 406 in clockwise direction 410 under the bias of slip disc rotation spring 404. Knob 406 is rotated clockwise until forwardly-extending tabs 436 of slip disc 402 engage respective leading edges 3220 (FIG. 14) of locking plate 352 (i.e., about 35°). The engagement of forwardly-extending tabs 436 of slip disc 402 with respective leading edges 3220 of locking plate 352 block further rotation of slip disc 402. The 35° angle corresponds to the angle between trailing edge 3222 of a segment 3204 of locking plate 352 and leading edge 3220 of the next segment 3204 of locking plate 352 (as viewed from end 326 of assembly 330). While the rotation of slip disc 402 is blocked at this point by locking plate 352, knob 406 is allowed to rotate further in clockwise direction 410 against the bias of slip disc rotation spring 404 until rearwardly-extending tab 438 of slip disc 402 moves away from the first radial rib 440 (FIG. 11) of knob 406 and engages second radial rib 442 (FIG. 11) of knob 406 (i.e., about 35°), at which point knob 406 is blocked from continued clockwise rotation in direction 410. The 35° angle corresponds to the angle between first and second radial ribs 440, 442 of knob 406.

The clockwise rotation of knob 406 in direction 410 by about 70°, causes clockwise rotation of drive shaft 344 and lifting cam 346, also through about 70°. The clockwise rotation of lifting cam 346 by about 70° causes locking bar 338 to move away from support plates 348, 350 and, in turn, causes locking tabs 3108 (FIG. 9) of locking bar 338 to retract from the tab-receiving slots 378, 380 in rear support plate 350 to free support plates 348, 350 to rotate relative to each other. Support plates 348, 350 may then be rotated to a step ladder configuration, to an extension ladder configuration or to a collapsed configuration as the case may be, at which point locking tabs 3108 of locking bar 338 snap back into tab-receiving slots 378, 380 in rear support plate 350 under the bias of snap spring 340 to again lock support plates 348, 350 in place. Knob 406 is then released.

When knob 406 is released (1) knob 406 moves away from rear support plate 350 under the bias of knob spring 358, and (2) slip disc 402 moves with knob 406 away from locking plate 352 so that forwardly-extending tabs 436 of slip disc 402 disengage from respective leading edges 3220 of locking plate 352 to free slip disc 402 to rotate clockwise under the bias of slip disc rotation spring 404 until rearwardly-extending tab 438 of slip disc 402 re-engages first radial rib 440 of knob 406 (i.e., about 35°). Thus, slip disc 402 is reset or advanced to the starting position of a next unlocking cycle, where knob 406 is again ready to be pushed in and rotated in clockwise direction 410 to unlock hinge and locking assembly 330.

1. Lock apparatus comprising
a lockable joint including first and second hinge members coupled together for rotation about an axis,
a lock movable between a locking position in which the hinge members are locked to prevent the hinge members from rotating about the axis and a releasing position in which the hinge members are unlocked to permit the hinge members to rotate about the axis,
a knob rotatable about the axis and movable along the axis, the lock moving from the locking position to the releasing position in response to movement of the knob axially toward the hinge members and then rotation of the knob about the axis, and
a lock indicator member mounted for movement along the axis between a first position and a second position in response to axial movement of the knob to allow a user to determine whether the hinge members are locked or unlocked by observing whether the lock indicator member is in the first position or the second position.

2. The lock apparatus of claim 1, wherein the lock indicator member is arranged to move from the first position to the second position in response to axial movement of the knob toward the hinge members.

3. The lock apparatus of claim 1, wherein the lock indicator member is arranged to move from the first position when the hinge members are locked to the second position when the hinge members are unlocked in response to axial movement of the knob toward the hinge members and then rotation of the knob about the axis.

4. The lock apparatus of claim 1, wherein the lockable joint includes a drive shaft rotatable about the axis, the hinge plates are rotatably mounted on the drive shaft, and the lock is coupled to the drive shaft for axial movement toward and away from the hinge members.

5. The lock apparatus of claim 4, wherein the drive shaft includes a bore receiving the lock indicator member for axial movement therein, the lock indicator member has a first end configured to engage the knob when the knob is moved axially toward the hinge members and a second end, and the lock is mounted on the lock indicator member near the second end for axial movement therewith.

6. The lock apparatus of claim 5, wherein the lockable joint includes a cover and the second end of the lock indicator member extends through an opening in the cover when the hinge members are unlocked.

7. The lock apparatus of claim 6, wherein the second end of the lock indicator member retracts into the cover when the hinge members are locked.

8. The lock apparatus of claim 7, wherein the lockable joint includes a spring biasing the lock toward the hinge members so that the second end of the lock indicator member retracts into the cover when the hinge members are locked.

9. The lock apparatus of claim 4, wherein the lock is rotatably mounted on the drive shaft and the knob is mounted on the drive shaft for rotation therewith.

10. The lock apparatus of claim 9, wherein the knob has a hub portion, the drive shaft has a non-round portion, and the hub portion of the knob has a complementary non-round bore receiving the non-round portion of the drive shaft so that the knob is movable axially along the drive shaft while transmitting the rotation of the knob to the drive shaft.

11. The lock apparatus of claim 1, wherein the lockable joint includes a cam configured to move the lock to the releasing position in response to movement of the knob axially toward the hinge members and then rotation of the knob about the axis.

12. The lock apparatus of claim 11, wherein the cam is mounted on the drive shaft for rotation therewith.

13. The lock apparatus of claim 1, wherein the lockable joint includes a cover, the lock indicator member has a first end configured to engage the knob when the knob is moved axially toward the hinge members and a second end, the lock is mounted on the lock indicator member near the second end for axial movement therewith, and the second end of the lock indicator member extends through an opening in the cover when the hinge members are unlocked.

14. The lock apparatus of claim 13, wherein the second end of the lock indicator member retracts into the cover when the hinge members are locked.

15. The lock apparatus of claim 14, wherein the lockable joint includes a spring biasing the lock toward the hinge members so that the second end of the lock indicator member retracts into the cover when the hinge members are locked.

16. The lock apparatus comprising first and second hinge members that, when locked, are prevented from rotating about an axis and that, when unlocked, are permitted to rotate about the axis, and a lock indicator member arranged to move between a retracted position when the hinge members are locked and an extended position when the hinge members are unlocked to allow a user to determine whether the hinge members are locked or unlocked by observing whether the lock indicator member is in the retracted position or the extended position.

17. The lock apparatus of claim 16, further comprising a cover, wherein an end of the lock indicator member extends through an opening in the cover when the hinge members are in the unlocked.

18. The lock apparatus of claim 17, wherein the end of the lock indicator member retracts into the cover when the hinge members are locked.

19. The lock apparatus of claim 18, further comprising a spring biasing the lock indicator member toward the retracted position so that the end of the lock indicator member retracts into the cover when the hinge members are locked.

20. The lock apparatus of claim 19, wherein the lock indicator member is arranged to move along the axis.

21. The lock apparatus of claim 20, further comprising a lock movable between a locking position in which the hinge members are locked and a releasing position in which the hinge members are unlocked and a knob rotatable about the axis and movable along the axis, wherein the lock is arranged to move from the locking position to the releasing position in response to movement of the knob axially toward the hinge members and then rotation of the knob about the axis, and the lock indicator member is arranged to move along the axis from the retracted position to the extended in response to movement of the knob.

22. The lock apparatus of claim 21, further comprising a drive shaft rotatable about the axis, and wherein the hinge members are rotatably mounted on the drive shaft and the lock is coupled to the drive shaft for axial movement toward and away from the hinge members, and the knob is mounted on the drive shaft for rotation therewith.

23. The lock apparatus of claim 22, further comprising a cam configured to move the lock to the releasing position in response to movement of the knob axially toward the hinge members and then rotation of the knob about the axis.

24. The lock apparatus of claim 23, wherein the cam is mounted on the drive shaft for rotation therewith.
